(19) United States
(12) Patent Application Publication
(10) Pub. No.: US 2009/0066842 A1
(43) Pub. Date: Mar. 12, 2009

(54) Image processing apparatus

(75) Inventors: Toshihiro Hattori, Okazaki-city (JP); Bingchen Wan, Okazaki-city (JP); Masayuki Imanishi, Okazaki-city (JP)

Correspondence Address: POSZ LAW GROUP, PLC, 12040 SOUTH LAKES DRIVE, SUITE 101, RESTON, VA, 20191, US

(73) Assignees: DENSO CORPORATION, Kariya-ctiy (JP); NIPPON SOKEN, INC., Nishio-city (JP)

(21) Appl. No.: 12/230,346

(22) Filed: Aug. 28, 2008

(30) Foreign Application Priority Data
Sep. 7, 2007 (JP) 2007-232811

(51) Int. Cl. H04N 5/00

(52) U.S. Cl. 348/607; 348/E05.001

(57) ABSTRACT

An image processing apparatus executes distortion compensation based on distortion compensation information associated with desired distortion compensation and an angle of view of an image currently being displayed on a display device. Distortion compensation can be performed stepwise without use of any other distortion compensation information until a distortion compensated state is realized based on distortion compensation information stored in a memory unit. Distortion compensation based on a level received by an operating unit is provided. An image having undergone distortion compensation can be displayed. The number of distortion compensation information items need not be increased proportionally to the number of levels for a magnitude of distortion compensation to be implemented since distortion compensation can be stepwise implemented from the current distortion compensation until a magnitude of distortion compensation is realized based on specific distortion compensation information.

### CROSS REFERENCE TO RELATED APPLICATIONS

The present invention is based on and claims priority to Japanese Patent Application No. 2007 232811, filed on Sep. 7, 2007, the entire contents of which are incorporated herein by reference.

### BACKGROUND OF THE INVENTION

1. Field of the Invention

The present invention relates to an image processing apparatus to compensate for distortion in an image captured by a camera mounted on a vehicle.

2. Description of the Related Art

Image processing apparatuses that display an image captured by a vehicle mounted camera on a display device at a time depending on the behavior of the vehicle, or that change an angle of view of the image depending on the behavior of the vehicle, and that display the image on the display device have recently become known. In one example, a vehicle backing assistance apparatus described in JP-A-2005-112267 decides whether a vehicle is backed, after having advanced and parked, based on signals inputted from a shift position sensor, a vehicle speed sensor, and a parking brake sensor respectively. Based on the result of the decision, a wide-angle image of a wide horizontal angle of view and a narrow-angle image of a narrow horizontal angle of view are switched and displayed. Reference can be made, for example, to paragraph [0039] of JP-A-2005-112267.

In order to obtain a wide-angle image, a camera generally has to include a wide-angle lens or a so-called fisheye lens. A camera included in the vehicle backing assistance apparatus described in JP-A-2005-112267 includes a wide-angle lens covering a horizontal angle of view of, for example, 170°. Difficulties arise however in that, the perimeter of a wide angle image displayed on a display device suffers from excessive distortion.

The distortion in the perimeter of an image displayed on a display device may be compensated according to an image distortion compensation technology. However, the degree of the distortion in the perimeter of an image varies depending on the angle of view of the image displayed on the display device. Further, compensation can make the image more difficult to discern depending on the angle of view of the image, and a degree of compensation required to reduce or eliminate the distortion can vary depending on the likes of a driver. If the degree of distortion compensation is fixed to a constant value, such an image processing apparatus becomes difficult for the driver to use.

### SUMMARY OF THE INVENTION

The present invention addresses the foregoing and other problems, and provides an image processing apparatus that can execute distortion compensation.

An image processing apparatus in accordance with various aspects includes an image input means that inputs an image by means of a video signal, an image output means that outputs the image inputted by the image input means, by means of the video signal, an angle-of-view switching means that switches angles of view for the image inputted by the image input means, a distortion compensation execution means that performs distortion compensation on the image outputted by the image output means, a command reception means that receives a command relevant to distortion compensation from a user, and a distortion compensation change means that changes the distortion compensation performed by the distortion compensation means to distortion compensation associated with the angle of view selected by the angle-of-view switching means and the command received by the command reception means.

According to the foregoing image processing apparatus, distortion compensation desired by a user and matched with an angle of view of an image to be displayed on the display device can be implemented.

The distortion compensation execution means can execute predetermined distortion compensation alone, or, in accordance with another aspect, an image processing apparatus may further include a memory means in which distortion compensation information including information associated with distortion compensation methods are stored. The distortion compensation change means may read distortion compensation information associated with an angle of view selected by the angle-of-view switching means and a command received by the command reception means, from the memory means, and allow the distortion compensation execution means to execute the distortion compensation based on the read distortion compensation information.

Distortion compensation information to be stored in the memory can be changed to distortion compensation information permitting realization of user-desired distortion compensation.

Distortion compensation information which forms the basis for magnitudes of distortion compensation having stepwise differences from one another may be stored in the memory means in association with levels so that stepwise distortion compensation can be implemented. Alternatively, the distortion compensation change means may be able to allow the distortion compensation execution means to execute stepwise distortion compensation without use of any other distortion compensation information until a distortion compensated state is realized based on distortion compensation information stored in the memory means, and may allow the distortion compensation execution means to execute distortion compensation based on a level received by the command reception means.

When compensation information is not used, the amount of distortion compensation information to be stored in the memory means proportional to the number of levels required for a magnitude of distortion compensation to be implemented can be reduced. Nevertheless, distortion compensation can be implemented stepwise based on the distortion compensated state until a magnitude of distortion compensation is realized based on specific distortion compensation information.

More specifically, the distortion compensation change means preferably divides a magnitude of compensation for distortion compensation to be implemented based on distortion compensation information stored in the memory means, associates the divisions with levels, and allows the distortion compensation execution means to execute distortion compensation by a magnitude of compensation associated with a level received by the command reception means. For example, assume that pixel information, such as luminance information or saturation information associated with pre-compensation coordinates (X1, Y1), is shifted to coordinates (X2, Y2) after distortion compensation is implemented based on distortion compensation information stored in the memory means. Assuming that N denotes the number of divisions of the magnitude of the shift and k denotes a designated level, the shift destination of the pixel information associated with the pre-compensation coordinates (X1, Y1) are represented by (X1+(X2−X1)*k/N, Y1+(Y2−Y1)*k/N). As the magnitude of compensation is divided, the magnitude of a shift of pixel information may be correspondingly divided. Alternatively, the magnitude of the shift of pixel information may be set to a specified magnitude based on distortion compensation information, and a magnitude of a change in pixel information associated with a pixel that is a shift destination may be divided. Specifically, when I denotes the pixel information associated with the pre-compensation coordinates (X1, Y1) and I′ denotes the pixel information associated with coordinates (X1, Y1) obtained after distortion compensation is implemented based on the distortion compensation information stored in the memory means, assuming that N denotes the number of divisions of a magnitude of a change and m denotes the designated number of levels, pixel information I″ on the post-compensation coordinates (X1, Y1) is represented by the expression I″=I+(I′−I)*k/N.

According to the above, stepwise distortion compensation can be implemented using a simple expression. A corresponding processing load incurred by the image processing apparatus is limited.

It should be noted that the distortion around the perimeter of an image associated with a narrow angle of view is smaller than that in the perimeter of an image associated with a wide angle of view. Assuming that angles of view can be switched in two steps, the distortion compensation execution means may be configured execute distortion compensation only when the angle of view selected by the angle-of-view switching means is a wide angle of view. When the angle of view selected by the angle-of-view switching means is not a wide angle of view, the command reception means does not receive a command relevant to distortion compensation from a user. If the command reception means does receive a command from the user when the selected angle of view is not a wide angle, the distortion compensation change means does not respond to the command.

If the image processing apparatus is constructed as mentioned above, the processing load to be incurred by the image processing apparatus is limited.

### BRIEF DESCRIPTION OF THE DRAWINGS

FIG. 1 is a block diagram illustrating an exemplary configuration of an image processing apparatus according to an embodiment;

FIG. 2A to FIG. 2C are flowcharts illustrating exemplary operations to be performed by an image processing apparatus according to embodiments;

FIG. 3A is a diagram illustrating an exemplary history table;

FIG. 3B is a diagram illustrating an exemplary distortion compensation information ID specification table;

FIG. 4A is a diagram illustrating an exemplary image to be displayed on a display device;

FIG. 4B is a diagram illustrating another exemplary image to be displayed on a display device;

FIG. 5A is a diagram illustrating an exemplary image and control associated with a display device;

FIG. 5B is a diagram further illustrating an exemplary image and control associated with a display device;

FIG. 6A to FIG. 6D are diagrams illustrating stepwise distortion compensation;

FIG. 7A to FIG. 7C are diagrams further illustrating stepwise distortion compensation; and

FIG. 8 is a block diagram illustrating an exemplary configuration of an image processing apparatus according to a variant of an embodiment.

### DETAILED DESCRIPTION OF THE EXEMPLARY EMBODIMENTS

Referring to the drawings, various exemplary embodiments to which the invention can be applied will be described below. It should be noted that the invention is not limited to the embodiments described below, but can assume various forms.

### First Embodiment

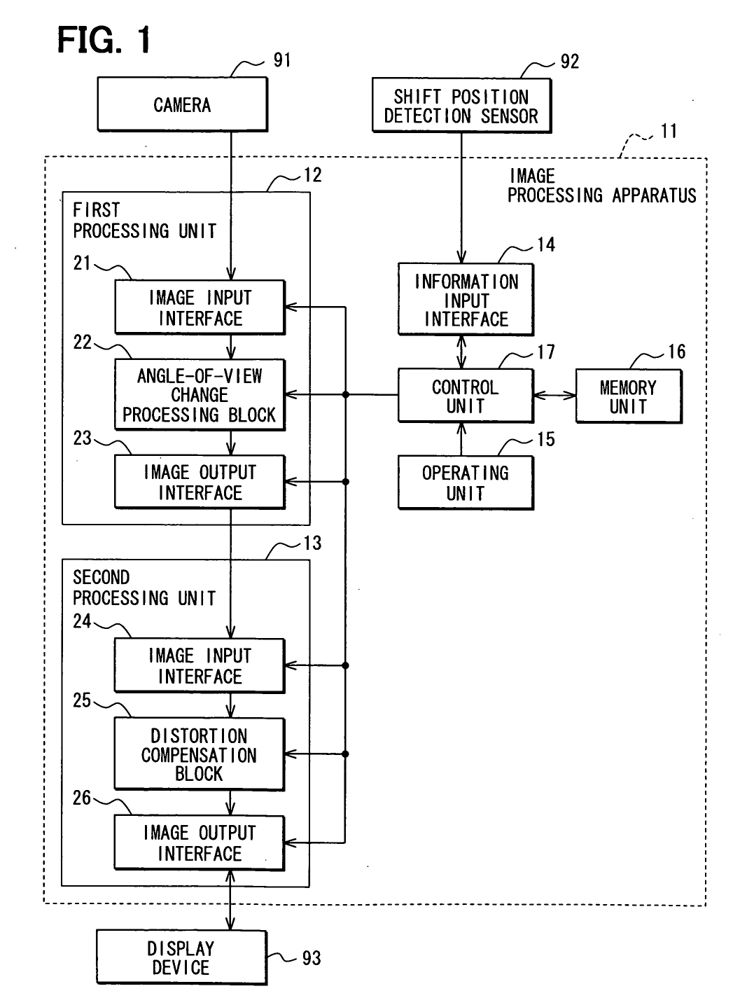

An image processing apparatus 11 associated with a first embodiment includes various devices connected thereto as shown in FIG. 1 including a camera 91, a shift position detection sensor 92, and a display device 93. It will be appreciated that while the word image is used extensively herein, the term image can be applied to a static image, or a video feed, such as a series of static images that together make up a video image display, such as a live video monitor. The image processing apparatus 11 is capable of inputting a raw image having an angle of view from the camera 91, switching the raw image and an image of a narrow angle of view produced from the raw image, and outputting a selected image to the display device 93. The image processing apparatus 11 includes a first processing unit 12, a second processing unit 13, an information input interface 14 through which a shift position signal is inputted from the shift position detection sensor 92, an operating unit 15, a memory unit 16, and a control unit 17.

The first processing unit 12 changes the angle of view of an inputted image, such as cutting out or zooming in part of an image, and includes an image input interface 21 through which a video signal is inputted from the camera 91, an angle-of-view change processing block 22, and an image output interface 23 through which a video signal produced by the angle-of-view change processing block 22 is outputted to the second processing unit 13.

The angle-of-view change processing block 22 changes a video signal passed from the image input interface 21 to an image of a narrow angle of view narrower than the angle of view of a raw image, such as an angle of view of 130°, in response to a command sent from the control unit 17. Changing an angle of view is achieved according to a known digital image processing technology such as a technology for cutting out or digitally zooming in part of an image, whereby a narrow-angle image is produced. It should be noted that the angle-of-view change processing block 22 may output a video signal of a raw image whose angle of view is not changed, such as a wide-angle image, without any change.

The second processing unit 13 executes distortion compensation for an image inputted from the first processing unit 12, and includes an image input interface 24 through which a video signal is inputted from the first processing unit 12, a distortion compensation block 25, and an image output interface 26.

The distortion compensation block 25 executes distortion compensation for an image produced based on the video signal passed from the image input interface 24, in response to an instruction sent from the control unit 17. The distortion compensation block 25 may output the video signal passed from the image input interface 24, to the image output interface 26 without any change, that is, without any distortion compensation in response to an instruction sent from the control unit 17. The image output interface 26 is an interface through which a video signal sent from the distortion compensation block 25 is outputted to the display device 93.

The operating unit 15 includes a touch panel layered on or integrated into the display surface of the display device 93, mechanical switches arranged around the display device 93, and a steering switch disposed on a steering wheel, and that permits a user to input an operating command to the image processing apparatus 11.

The memory unit 16 includes a nonvolatile storage medium such as a hard disk or a flash memory, and stores distortion compensation information associated with distortion compensation methods, a history table containing an ID or the like assigned to previously used distortion compensation information, and a distortion compensation information ID specification table to be referenced in order to specify a distortion compensation information ID associated with an angle of view. The distortion compensation information and tables will be described in greater detail hereinafter.

The control unit 17 can be a known microcomputer, and can have the capability for executing various processing by controlling the foregoing components according to a program or programs stored in memory such as a read only memory (ROM), a flash memory, or the like.

The camera 91 can be an onboard camera mounted on the rear part of a vehicle and can image a range around the vehicle at an angle of view of 180°. An image captured by the camera 91 is transmitted as a video signal to the image processing apparatus 11 according to a known wired or wireless method.

The shift position detection sensor 92 can be included in a transmission (not shown), and detects a shift position in the transmission. Based on a signal sent from the shift position detection sensor 92, it can be learned whether the current shift position is a drive (D) position, a neutral (N) position, or a reverse (R) position.

The display device 93 includes a color image display unit (not shown) such as a liquid crystal panel or the like, that displays an image according to a video signal inputted from the image processing apparatus 11 according to a wired method. It should be noted that, while not shown, the touch panel of the operating unit 15 is layered on or integrated into the display surface of the color image display unit as would be well understood by one of ordinary skill.

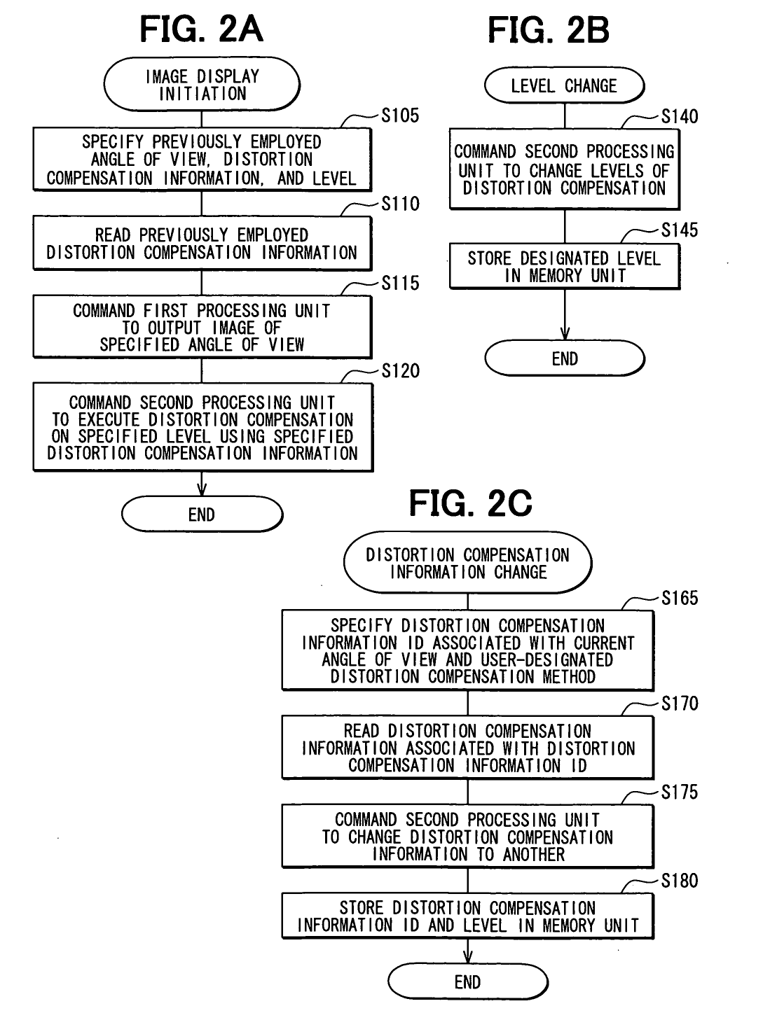

An operation to be performed by the image processing apparatus 11 at the time of initiating display of an image will be described in conjunction with the flowchart of FIG. 2A. Displaying an image can only be executed in a vehicle backing state. Specifically, display of an image can be initiated in a state in which the control unit 17 has received a signal from the shift position detection sensor 92 through the information input interface 14 signifying that the current shift position is the R position.

In the vehicle backing state, when the control unit 17 receives an image display instruction from a user via the operating unit 15, the control unit 17 specifies a previously employed angle of view, distortion compensation information, and a level of distortion compensation by referencing the history table at S105.

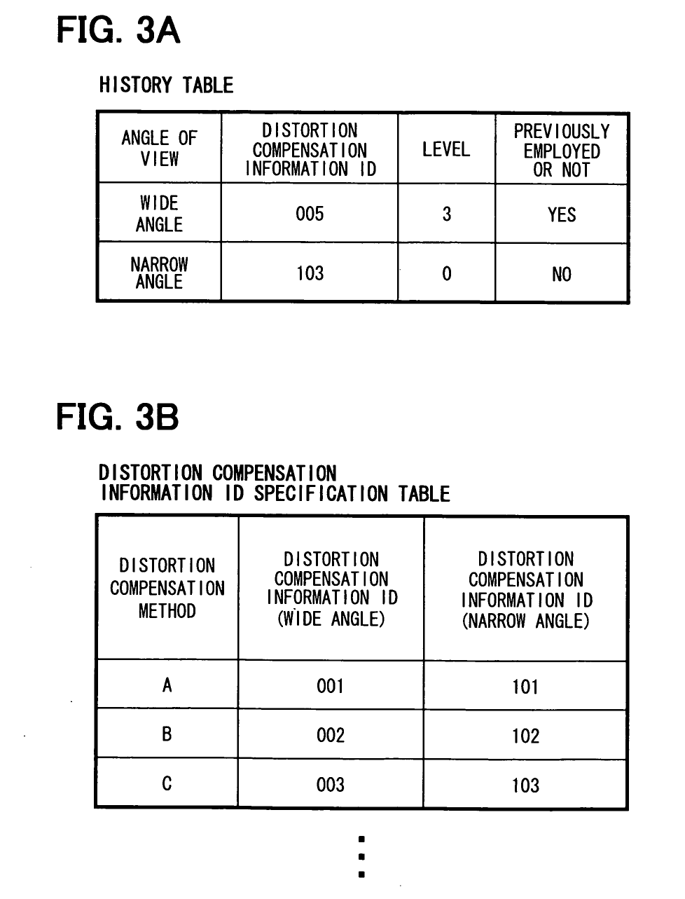

The history table will be concretely described in conjunction with the illustrative table shown in the diagram of FIG. 3A. As shown, each of the records in the history table has items including Angle of View, Distortion Compensation Information ID, Level, and Previously Employed or Not. The Angle of View item contains data signifying whether the angle of view of the image is a wide-angle of view or a narrow angle of view. The Distortion Compensation Information ID item contains an ID to be used to identify distortion compensation information associated with the distortion compensation performed last on an image covering an angle of view represented by the data entered in the Angle of View item of the record concerned and that will be referred to as a specified angle of view, is entered. The Level item contains a numeral representing the level of distortion compensation performed last on the image of the specified angle of view is entered. The Previously Employed or Not item contains data such as “yes” or “no,” true or false, or the like, signifying whether the associated image was displayed last. It will be appreciated that the number of records in the history table having “yes” specified therein at a given time should be only one. In the present example of FIG. 3A, the history table demonstrates that the angle of view of an image displayed last on the display device 93 is a wide angle of view, that the distortion compensation method employed for the display is deduced from the distortion compensation information ID of “005,” and that the level of distortion compensation is “3.”

Referring back to FIG. 2A, the control unit 17 reads previously employed distortion compensation information from the memory unit 16 at S110 on the basis of the distortion compensation information ID specified at S105. Thereafter, the control unit 17 transmits a command signifying that an image of the angle of view specified at S105, that is, the wide angle of view or narrow angle of view should be outputted, to the first processing unit 12 at S115.

The image input interface 21 of the first processing unit 12 having received the command at S115 begins transmitting a video signal produced by the camera 91, to the angle-of-view change processing block 22. If the angle of view specified at S105 is the narrow angle of view, the angle-of-view change processing block 22 having received the command at S115 begins performing digital image processing on the received image that is a raw image, and then transmitting the resultant image to the image output interface 23. The digital processing is to cut out an area, which covers an angle of view of 130°, from the input image that is the raw image, and digitally zoom in the cut area. On the other hand, if the angle of view specified at S105 is the wide angle of view, the raw image or wide-angle image is transmitted to the image output interface 23 as it is without any change in the angle of view. Moreover, the image output interface 23 of the first processing unit 12 having received the command at S115 begins transmitting the video signal passed from the angle-of-view change processing block 22, to the second processing unit 13.

Thereafter, the control unit 17 transmits a command to the second processing unit 13 signifying that compensation of the level of distortion compensation of the image specified at S105 should be performed based on the distortion compensation information read at S110, at S120.

The image input interface 24 of the second processing unit 13, having received the command at S120, transmits the video signal passed from the first processing unit 12, to the distortion compensation block 25. Having received the command at S115, the distortion compensation block 25 begins performing distortion compensation on the received video signal and then transmits the resultant video signal to the image output interface 26. An example of distortion compensation will be described in greater detail hereinafter. Having received the command at S115, the image output interface 26 begins transmitting the video signal received from the distortion compensation block 25, to the display device 93.

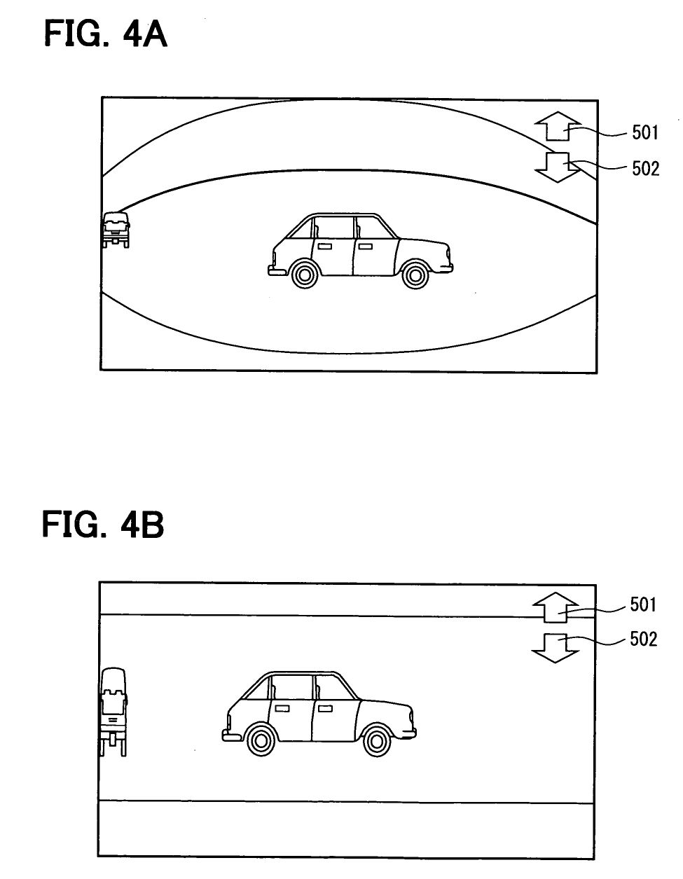

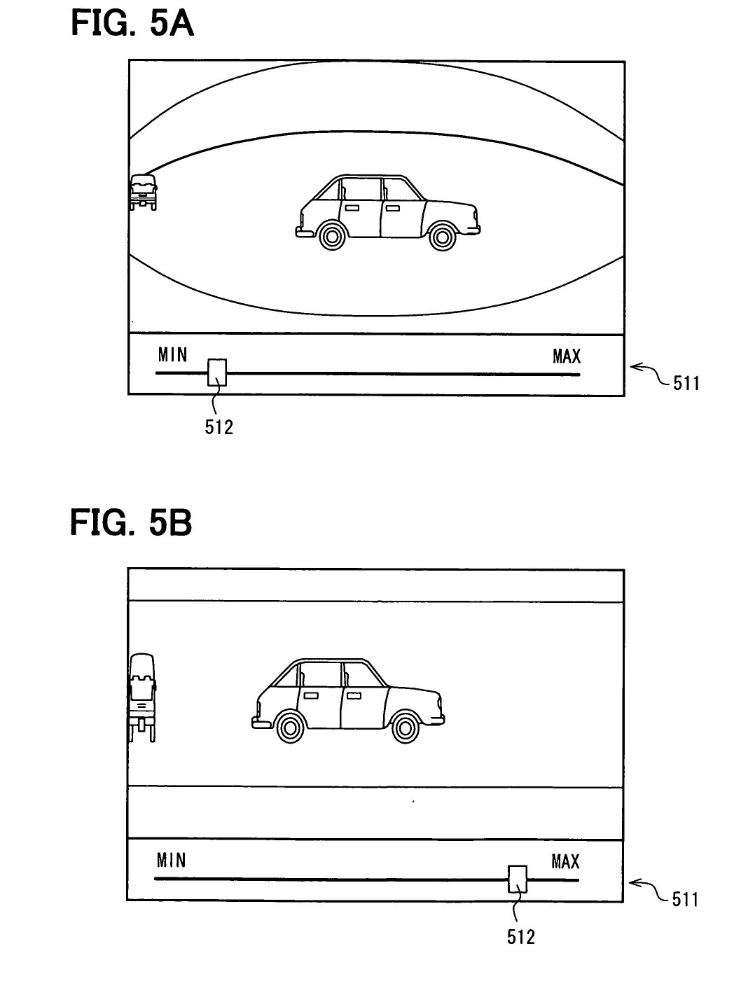

As a result, an image having undergone distortion compensation is displayed on the display device 93 as shown in FIG. 4A to FIG. 5B. As shown, another vehicle is located behind the vehicle in which the image processing apparatus 11 is mounted, and still another vehicle located leftward with respect to the vehicle. FIG. 4A and FIG. 4B show the images having undergone different levels of distortion compensation. The shapes of the vehicle shown in the left-hand edges of the images demonstrate that the image shown in FIG. 4B has undergone distortion compensation to a greater extent. Operating icons, such as an upward arrow icon 501 and a downward arrow icon 502 superimposed on the images shown in FIG. 4A and FIG. 4B are used for controlling compensation. By interacting with the upward arrow icon 501, a user can raise the level of distortion compensation, and, by interacting with the downward arrow icon 502, the user can lower the level of distortion compensation. An operation to be performed by the image processing apparatus 11 when either of the arrows is manipulated, or when an instruction is given to switch levels of distortion compensation will be described in greater detail hereinafter.

FIG. 5A and FIG. 5B shows images having undergone different levels of distortion compensation. The shapes of the vehicle shown in the left-hand edges of the images demonstrate that the image shown in FIG. 5B has undergone distortion compensation to a greater extent. Moreover, a slider 511 is depicted in the lower parts of the images shown in FIG. 5A and FIG. 5B. A user can interact with and thus move an operating piece 512 of the slider 511 leftward toward an indicator “Min” or rightward toward an indicator “Max” to control a level of distortion compensation. In other words, when the operating piece 512 is moved leftward, the level of distortion compensation can be lowered. When the operating piece 512 is moved rightward, the level of distortion compensation can be raised. An operation to be performed by the image processing apparatus 11 when the operating piece 512 is manipulated or when switching of levels of distortion compensation is instructed will be described in greater detail hereinafter.

Next, an operation to be performed by the image processing apparatus 11 at the time of changing levels of distortion compensation will be described in conjunction with the flowchart of FIG. 2B. Changing levels of distortion compensation is an operation that can be performed in a state in which an image having undergone distortion compensation is displayed on the display device 93, and is an operation whose execution is initiated when the control unit 17 has received an instruction, which instructs switching of levels of distortion compensation, from a user via the operating unit 15. Specifically, when the user manipulates the arrow 501 or arrow 502 oriented upward or downward and shown in FIG. 4A and FIG. 4B, or the operating piece 512 of the slider 511 shown in FIG. 5A and FIG. 5B, the operation of switching the levels of distortion compensation is initiated.

When the operation of switching levels of distortion compensation is initiated, the control unit 17 transmits a command of changing levels of distortion compensation to the second processing unit 13 at S140. Specifically, in the case shown in FIG. 4A and FIG. 4B, a decision whether the level of distortion compensation should be raised or lowered based on a manipulation performed on the upward arrow icon 501 or the downward arrow icon 502 is transmitted to the second processing unit 13. In the case shown in FIG. 5A and FIG. 5B, a level of distortion compensation specified based on a manipulation performed on the operating piece 512 of the slider 511 is transmitted to the second processing unit 13. The control unit 17 then stores the level of distortion compensation designated by the user in the history table in the memory unit 16 at S145.

The distortion compensation block 25 of the second processing unit 13, having received the command at S140, changes levels of distortion compensation in response to the received command. A method of realizing stepwise distortion compensation will be described in greater detail hereinafter. As a result, an image having the level of distortion compensation changed to another is displayed on the display device 93.

Next, an operation to be performed by the image processing apparatus 11 at the time of changing distortion compensation information to be referenced will be described in conjunction with the flowchart of FIG. 2C. Changing distortion compensation information can be performed when an image is displayed on the display device 93, and can be initiated when the control unit 17 has received a desired distortion compensation method from a user via the operating unit 15. Specifically, for example, mechanical key switches or operating icons associated with methods A, B, and C respectively are made ready. When any of the key switches or operating icons is depressed, the operation is initiated.

When the operation of changing distortion compensation information is initiated, the control unit 17 specifies a distortion compensation information ID associated with a currently displayed angle of view and a distortion compensation method received from a user by referencing the distortion compensation information ID specification table at S165. As shown in conjunction with the illustrative table diagram of FIG. 3B, each of records in the distortion compensation information ID specification table has items including Distortion Compensation Method ID, Wide Angle Distortion Compensation Information ID, and Narrow Angle Distortion Compensation Information ID items. The Narrow and Wide Distortion Compensation Method ID are items in which an ID capable of specifying a distortion compensation method designated by a user is entered. Data of the Wide Angle Distortion Compensation Information ID specifies a distortion compensation information ID associated with a wide angle distortion compensation method applied to a wide-angle image displayed on the display device 93. Data of the Narrow Angle Distortion Compensation Information ID specifies a distortion compensation information ID associated with a narrow-angle distortion compensation method applied to a narrow-angle image is displayed on the display device 93. Consequently, for example, assuming that the wide-angle image is displayed on the display device 93, when a user depresses the key switch associated with the method B, “002” is specified as the distortion compensation information ID.

Referring back to FIG. 2C, the control unit 17 reads distortion compensation information associated with the distortion compensation information ID specified at S165, from the memory unit 16 at S170. At S175, the control unit 17 transmits a command to the second processing unit 13 signifying that distortion compensation information to be employed should be changed to the distortion compensation information read at S170.

Having received the command, the distortion compensation block 25 changes the distortion compensation information employed in distortion compensation, to the distortion compensation information designated by the control unit 17, and performs distortion compensation on the image passed from the image input interface 25. It should be noted that a level of distortion compensation is initialized to a predetermined level, for example, an intermediate level without exception.

Thereafter, the control unit 17 updates the history table in the memory unit 16 according to the distortion information ID specified at S165 and the initialized level of distortion compensation at S180.

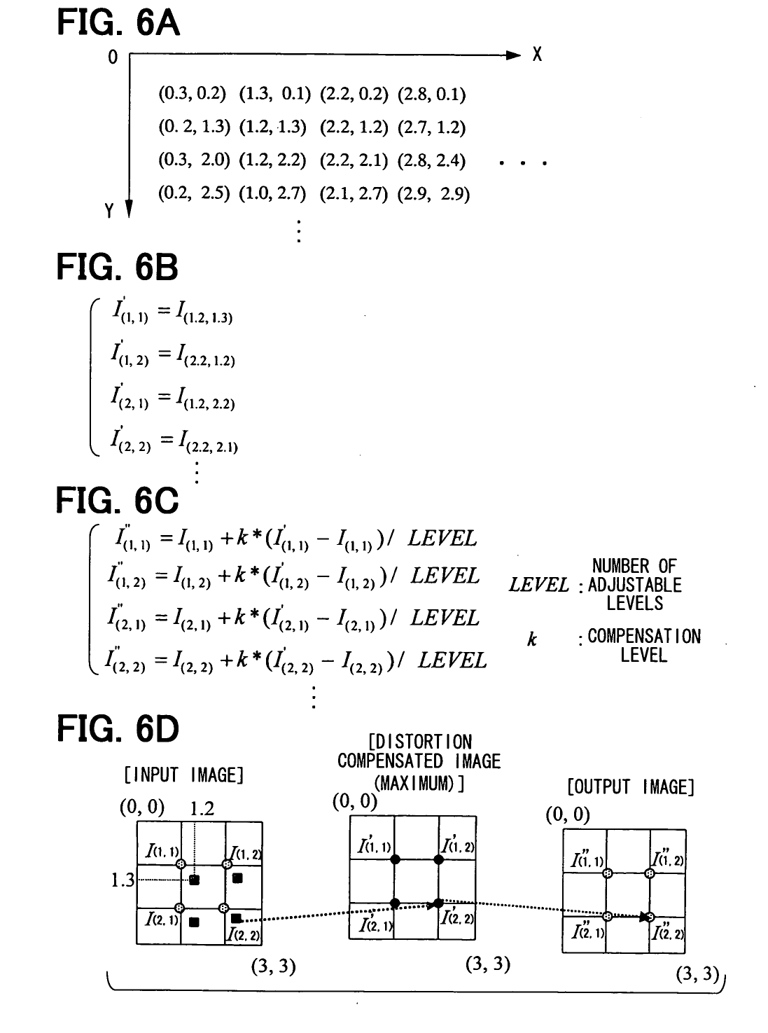

A first distortion compensation method includes realizing stepwise distortion compensation by a stepwise change of magnitudes of a change in pixel information associated with a destination pixel while setting a magnitude of a shift of the pixel information made during distortion compensation, to a specified value based on distortion compensation information. The method will be described in conjunction with FIG. 6A to FIG. 6D.

FIG. 6A shows an example of distortion compensation information expressed in a map form specifying the locations of pixel information, that is, luminance information or saturation information in association with particular pixesl constituting an image to be displayed on the display device 93 in order to perform distortion compensation on the maximum level. For example, distortion compensation information associated with a pixel represented by an x-coordinate of 1 and a y-coordinate of 1 is (1.2, 1.3) meaning that for distortion compensation, pixel information associated with a pixel located at a position represented by an x-coordinate of 1.2 and a y-coordinate of 1.3 is used as the pixel information associated with the pixel represented by the x-coordinate of 1 and y-coordinate of 1. If the pixel represented by the x-coordinate of 1.2 and the y-coordinate of 1.3 does not exist in an actual image, pixel information is estimated on the assumption that the pixel exists. For example, pixel information associated with a virtual pixel represented by the x-coordinate of 1.2 and the y-coordinate of 1.3, can be obtained by specifying pixels that actually exist around the virtual pixel, weighting the pixel information associated with the specified pixels according to the distances to the virtual pixel, and calculating a mean value.

Pixel information associated with pixels that will be employed on the assumption that the distortion compensation on the maximum level is performed are calculated as mentioned above. Differences from pixel information associated with pixels in an input image are calculated, and divided by a maximum number of levels. The quotients are multiplied by a desired level of distortion compensation. The products are added to the pixel information associated with the pixels in the input image. Thus, stepwise distortion compensation is implemented.

As shown in FIG. 6B and FIG. 6C, assume that I(x, Y) denotes pixel information in an input image, I′(x, Y) denotes pixel information in an image having undergone the distortion compensation on the maximum level, and I″(x, Y) denotes pixel information in an image having undergone the distortion compensation on a desired level. The pixel information in the image having undergone the distortion compensation on the maximum level are as expressed in FIG. 6B that shows pixel information associated with part of pixels. Moreover, the pixel information in the image having undergone the distortion compensation on the desired level are as expressed in FIG. 6C that shows pixel information associated with part of pixels. Visually expressed pixel information appears as shown in FIG. 6D. As shown in Input Image, for pixels located at intersections in a lattice and depicted with filled circles, pixel information associated with virtual pixels located nearby and depicted with filled squares are used as the pixel information associated with the pixels in the image having undergone the distortion compensation on the maximum level as in accordance with a Distortion Compensated Image item of a Maximum value. Differences between the pixels in the input image and the pixels in the maximum distortion-compensated image are calculated and divided by the maximum number of levels. The quotients are multiplied by a desired level of distortion compensation. The products are added to the pixel information associated with the pixels in the input image. Thus, an output image expressed in Output Image is obtained.

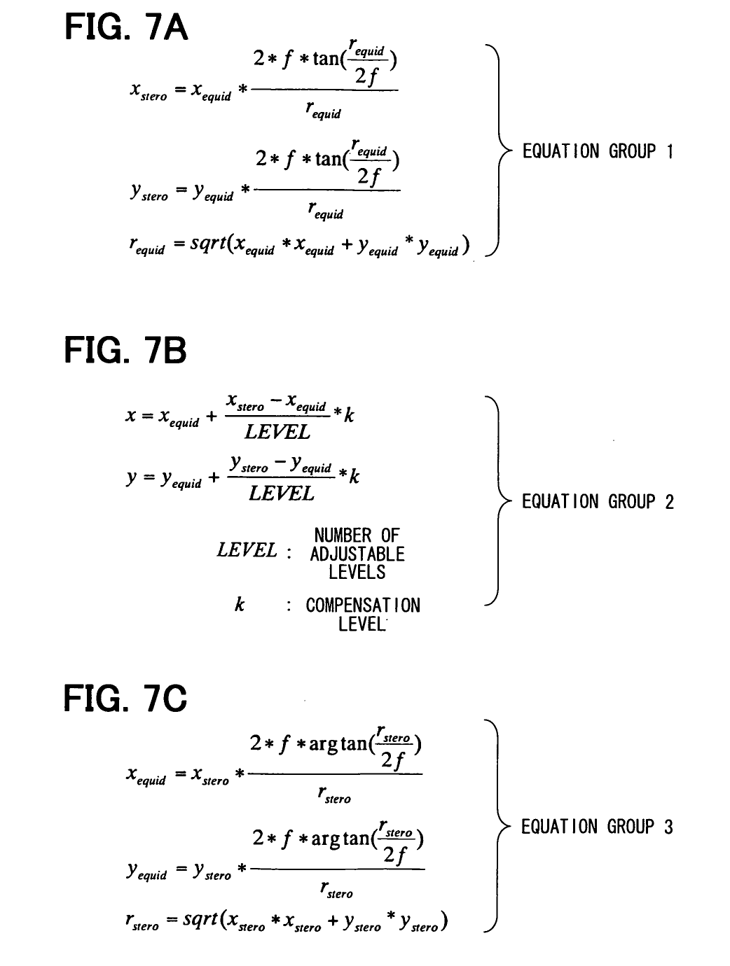

A second method realizes stepwise distortion compensation by stepwise changing a magnitude of a shift in pixel information for distortion compensation. The method will be described in conjunction with the explanatory diagrams of FIG. 7A to FIG. 7C.

An equation group 1 shown in FIG. 7A is an example of distortion compensation information including equations for use in correcting an image captured by a camera having an equidistant projection lens into an image equivalent to an image captured by a camera having a stereographic projection lens. A subscript “equid” refers to the equidistant projection method, and a subscript “stero” refers to the stereographic projection method. Moreover, “f” denotes the focal length of a lens.

In general, compared with an image captured by a camera having an equidistant projection lens, an image captured by a camera having a stereographic projection lens is characterized by a large amount of information associated with the perimeter of the image and by a small amount of information associated with the center thereof. Namely, a degree of distortion differs between the perimeter of the image and the center thereof.

An equation group 2 shown in FIG. 7B is an equation group for use in realizing stepwise distortion compensation. Using the equation group 1 and equation group 2, an image captured by a camera having an equidistant projection lens is stepwise corrected into an image equivalent to an image captured by a camera having a stereographic projection lens.

An equation group 3 shown in FIG. 7C is distortion compensation information for use in correcting an image captured by a camera having an equidistant projection lens, into an image equivalent to an image captured by a camera having a stereographic projection lens. The equation group 3 and an equation group having the subscripts “stero” and “equid” in the equation group 2 interchanged are used in combination, whereby the image captured by the camera having the stereographic projection lens can be stepwise corrected into the image equivalent to the image captured by the camera having the equidistant projection lens.

According to the aforesaid image processing apparatus 11, when a user changes distortion compensation information, the distortion compensation information that is associated with the user-desired distortion compensation method and that is also associated with the angle of view of an image currently displayed on the display device 93 is specified in order to execute distortion compensation at S165 to S175. Consequently, appropriate distortion compensation can be achieved.

Distortion compensation information and other information is stored in the memory unit 16 and can be changed. The image processing apparatus 11 can therefore be upgraded to be able to execute distortion compensation according to more appropriate distortion compensation information. The image processing apparatus 11 can further allow the distortion compensation block 25 to perform stepwise distortion compensation without use of any other distortion compensation information until a distortion compensated state is realized based on distortion compensation information stored in the memory unit 16, and allows the distortion compensation block 25 to perform distortion compensation on a level received by the operating unit 15, at S140. Consequently, without the necessity of increasing the number of distortion compensation information items to be stored in the memory unit 16 proportionally to the number of levels for a magnitude of distortion compensation to be implemented, distortion compensation can be stepwise implemented from the current distortion compensated state until a specific magnitude of distortion compensation is realized based on specific distortion compensation information.

The distortion compensation block 25 divides a magnitude of compensation for distortion compensation implemented based on distortion compensation information stored in the memory unit 16, and associates the divisions with levels. Thus, the distortion compensation block 25 performs distortion compensation by a magnitude of compensation associated with the level received by the operating unit 15. Refer to Method of Realizing Stepwise Distortion Compensation. Since stepwise distortion compensation is implemented using simple expressions, the processing load to be incurred by the image processing apparatus 11 is limited.

The correspondences of the terms employed in the description of the typical embodiment with the terms set forth in the claims is as follows. The image input interface 24 of the second processing unit 13 can act as the image input means. The control unit 17 can act as the angle-of-view switching means and distortion compensation change means. The image output interface 26 of the second processing unit 13 can act as the image output means. The distortion compensation block 25 can act as the distortion compensation execution means. The operating unit 15 can act as the command reception means. The memory unit 16 can act as the memory means.

### Other Embodiments

The above described image processing apparatus 11 of a first embodiment includes the angle-of-view change processing block 22a portion that can output an image produced by changing the angle of view of an inputted image. In a variant of a first embodiment, if a camera is independently provided with an angle-of-view change facility, the angle-of-view change processing block 22a portion may be excluded from the image processing apparatus 11.

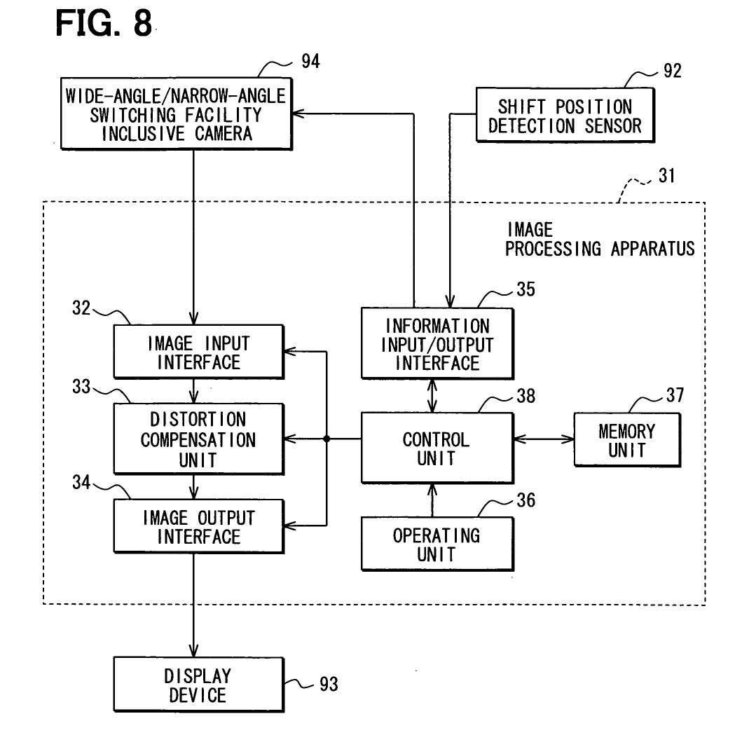

A concrete configuration of an image processing apparatus 31 shown in FIG. 8 is conceivable. A camera 94 including a wide-angle/narrow-angle switching facility, a shift position detection sensor 92, and a display device 93 are connected to the image processing apparatus 31. The camera 94 can switch and output a wide-angle image whose angle of view is, for example, 180° and a narrow-angle image whose angle of view is, for example, 130° in response to an external command by means of an optical mechanism. The shift position detection sensor 92 and display device 93 are identical to those described in connection with a first embodiment. The image processing apparatus 31 includes an image input interface 32 through which a video signal is inputted from the camera 94, a distortion compensation unit 33, an image output interface 34 through which a video signal of an image produced by the distortion compensation unit 33 is outputted to the display device 93, an information input/output interface 35 through which various signals are inputted from the shift position detection sensor 92 and through which an angle-of-view change instruction signal is outputted to the camera 94, an operating unit 36, a memory unit 37, and a control unit 38.

The distortion compensation unit 33 executes distortion compensation for an image produced based on the video signal passed from the image input interface 32, according to distortion compensation information and a level of distortion compensation that are designated based on an instruction sent from the control unit 38. The distortion compensation unit 33 may not execute distortion compensation but may output the video signal passed from the image input interface 32, to the image output interface 34 without any change in response to an instruction sent from the control unit 38.

The operating unit 36 includes a touch panel layered on or integrated into a surface of the display device 93, mechanical switches arranged around the display device 93, and a steering switch disposed on a steering wheel, and that permits a user to input an operating command to the image processing apparatus 31.

The memory unit 37 includes a nonvolatile storage medium such as a hard disk or a flash memory, and stores distortion compensation information or information associated with distortion compensation methods, and a history table containing an ID of previously employed distortion compensation information.

The control unit 38 can include a known microcomputer, and can execute various processing by controlling the foregoing components according to a program or programs stored in a read only memory (ROM), a flash memory, or the like.

A difference in an operation from the image processing apparatus 11 of a first embodiment and of the present variant is that in the image processing apparatus 11 of a first embodiment, the control unit 17 issues an angle-of-view change command to the angle-of-view change processing block 22. In the image processing apparatus 31 of the present variant, the control unit 38 outputs the angle-of-view change command to the camera 94 through the information input/output interface 35. The other operations are fundamentally identical to those performed by the image processing apparatus 11 of a first embodiment.

It should be noted that in the first variant, the image input interface 32 can act as the image input means. The control unit 38 can act as the angle-of-view switching means and distortion compensation change means. The image output interface 34 can act as the image output means. The distortion compensation unit 33 can act as the distortion compensation execution means. The memory unit 37 can act as the memory means.

The above described image processing apparatuses 11 and 31 of a first embodiment and a variant perform distortion compensation both when an image of a wide angle of view is displayed and when an image of a narrow angle of view is displayed. Alternatively, distortion compensation may be performed only when the image of the wide angle of view is displayed. Changing levels of distortion compensation or changing distortion compensation information may be executed only when the image of the wide angle of view is displayed.

In general, an image of a narrow angle of view of about 130° is characterized by an amount of distortion in the perimeter thereof that is less than that of an image of a wide angle of view of about 180°. Only when the image of the wide angle of view is displayed, if distortion compensation is performed, a sense of discrepancy between the images which a user will feel is presumably limited. In this case, the processing load to be incurred by the image processing apparatus is also limited.

What is claimed is:

1. An image processing apparatus comprising:
an image input means for inputting an image having a first angle of view, the image having a distortion compensation record;
an image output means for outputting the image to a display device;
a distortion compensation change means for changing a distortion compensation when the image is changed from the first angle of view to a second angle of view, the distortion compensation changed based on the distortion compensation record and a command supplied from an operational device; and
a distortion compensation execution means for performing a distortion compensation operation for the image according to the changed distortion compensation.

2. The image processing apparatus according to claim 1, further comprising a memory storing distortion compensation information items associated with the distortion compensation record, wherein:
the distortion compensation change means reads the stored distortion compensation information items associated with the second angle of view from the memory and the command; and
the distortion compensation execution means performs the distortion compensation based on at least one of the distortion compensation information items and the command.

3. The image processing apparatus according to claim 2, wherein:
the command includes a desired magnitude of distortion compensation; and
the distortion compensation change means causes the distortion compensation execution means to:
perform stepwise distortion compensation independent of the distortion compensation information items until a distortion compensated state is reached associated with the distortion compensation information items stored in the memory means, and
perform distortion compensation based on the desired magnitude.

4. The image processing apparatus according to claim 3, wherein the distortion compensation change means:
divides the desired magnitude into levels based on the distortion compensation information items in the memory means; and
causes the distortion compensation execution means to perform distortion compensation by a magnitude of compensation associated with one of the levels.

5. The image processing apparatus according to claim 1, wherein the first angle of view is a wide angle and the second angle of view is a narrow angle-of-view, and wherein the distortion compensation execution means performs distortion compensation only when an angle of view includes the wide angle of view.

6. An image processing apparatus comprising:
an image input means for inputting an image carried on a video signal;
an image output means for outputting the image inputted by the image input means to a display device using the video signal;
an angle-of-view switching means for switching an angle of view of the image;
a distortion compensation execution means for performing a distortion compensation for the image outputted by the image output means;
a command reception means for receiving a command associated with the distortion compensation; and
a distortion compensation change means for changing the distortion compensation performed by the distortion compensation execution means based on the angle of view switched to by the angle-of-view switching means and based on the command received by the command reception means.

7. The image processing apparatus according to claim 6, further comprising a memory means for storing one of distortion compensation information and distortion compensation method information, wherein:
the distortion compensation change means reads the stored one associated with the angle of view switched to by the angle-of-view switching means from the memory means and the command received by the command reception means; and
the distortion compensation execution means performs the distortion compensation based on the one and the command.

8. The image processing apparatus according to claim 7, wherein:
the command includes a desired magnitude of distortion compensation; and
the distortion compensation change means causes the distortion compensation execution means to:
perform stepwise distortion compensation without use of any other distortion compensation information until a distortion compensated state is realized based on the distortion compensation information stored in the memory means, and
perform distortion compensation based on the desired magnitude.

9. The image processing apparatus according to claim 8, wherein the distortion compensation change means:
divides the desired magnitude into levels based on distortion compensation information stored in the memory means; and
causes the distortion compensation execution means to perform distortion compensation by a magnitude of compensation associated with one of the levels.

10. The image processing apparatus according to claim 6, wherein the angle-of-view switching means switches the angle of view between a narrow angle of view and a wide angle of view, and the distortion compensation execution means performs distortion compensation only when the angle of view switched to by the angle-of-view switching means is the wide angle of view.
